(19) United States
(12) Patent Application Publication
(10) Pub. No.: US 2025/0236232 A1
(43) Pub. Date: Jul. 24, 2025

(54) AUTONOMOUS VEHICLE DELIVERY AND PACKAGE TRANSFER SYSTEM

(71) Applicants: Yi LI, Aurora (CA); Aldo VAN GELDER, Newmarket (CA); Adam NAISH, Rochester, MI (US); Azhagu SUBRAMANIAN, Troy, MI (US); Warren YOUNG, Troy, MI (US)

(72) Inventors: Yi LI, Aurora (CA); Aldo VAN GELDER, Newmarket (CA); Adam NAISH, Rochester, MI (US); Azhagu SUBRAMANIAN, Troy, MI (US); Warren YOUNG, Troy, MI (US)

(21) Appl. No.: 18/699,431

(22) PCT Filed: Oct. 7, 2022
(86) PCT No.: PCT/US2022/045970

§ 371 Date: Apr. 8, 2024

Related U.S. Application Data
(60) Provisional application No. 63/253,744, filed on Oct. 8, 2021.
(60) Provisional application No. 63/278,236, filed on Nov. 11, 2021.

(51) Int. Cl. B60P 3/00; B60P 1/00

(52) U.S. Cl. CPC B60P 3/007; B60P 1/003

(57) ABSTRACT

An autonomous package transfer system comprises a locker assembly including a storage compartment located at a destination. The locker assembly includes a locker door that is moveable between an open position and a closed position. An organizing mechanism is located in the storage compartment and includes a plurality of baskets that are moveable into alignment with the locker door via a drive unit. An autonomous vehicle delivery system includes at least one locker assembly located at a first destination and an autonomous vehicle. The locker assembly includes at least one storage compartment, the storage compartment including a door and a lock to selectively prevent access to the storage compartment. The autonomous vehicle comprises a chassis assembly and a storage assembly.

### CROSS-REFERENCE TO RELATED APPLICATION

This PCT International Patent Application claims the benefit of and priority to U.S. Provisional Patent Application Ser. No. 63/253,744 filed on Oct. 8, 2021 titled “Autonomous Vehicle Delivery System,” and U.S. Provisional Patent Application Ser. No. 63/278,236 filed on Nov. 11, 2021 titled “Autonomous Package Transfer System,” the entire disclosures of which are hereby incorporated by reference.

### BACKGROUND OF THE INVENTION

### 1. Field of the Invention

The present invention relates an autonomous package transfer system. More particularly, the present invention relates to an autonomous package transfer system including at least one autonomous vehicle and a locker assembly.

### 2. Related Art

This section provides background information related to the present disclosure which is not necessarily prior art.

As productivity and efficiency are the goals in any industrial environment, autonomous vehicles are being utilized, now more than ever, for a number of tasks. For example, autonomous vehicles are often used in warehouses for moving items from one location to another. These autonomous vehicles are designed to follow preprogramed paths and/or logic to move items, such as inventory, between two or more locations. Accordingly, inventory or other items can be loaded onto an autonomous vehicle at a first location whereafter the autonomous vehicle delivers the inventory or other items to a second location. While incorporating autonomous vehicles has greatly improved productivity in industrial environments, there are still a number of shortcomings associated with their use. For example, autonomous vehicles are typically designed for specifically defined tasks, such as the transportation of precisely sized inventory. As such, the functionality of autonomous vehicles is generally narrowly defined and not adaptable for additional uses, for example, delivery of items outside of precisely defined industrial environments.

Accordingly, there is a continuing desire to further develop and refine autonomous vehicle systems such that they are not subjected to traditional drawbacks and provide modifiable functionality, easy serviceability, and permit transferring, storing, and delivery of packages or items from one location to another.

### SUMMARY OF THE INVENTION

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims. This section provides a general summary of the disclosure and is not to be interpreted as a complete and comprehensive listing of all of the objects, aspects, features and advantages associated with the present disclosure.

According to one aspect of the disclosure, an autonomous package transfer system is provided. The autonomous package transfer system comprises a locker assembly located at a destination. The locker assembly includes a storage compartment having a locker door that is moveable between an open position and a closed position. The autonomous package transfer system also comprises an autonomous vehicle including a storage assembly; and a transfer assembly configured to move a package between the storage assembly of the autonomous vehicle and the storage compartment of the locker assembly.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 shows a perspective front view of an autonomous package transfer system including an autonomous vehicle and a first locker assembly in accordance with a first embodiment;

FIG. 2 shows a side view of the autonomous vehicle from FIG. 1 illustrating a first transfer assembly;

FIG. 3A shows a perspective view of the first transfer assembly in a stowed position;

FIG. 3B shows a perspective view of the first transfer assembly in an extended position;

FIG. 4 shows a perspective view of the autonomous package transfer system from FIG. 1 illustrating the first transfer assembly in the stowed position;

FIG. 5 shows a perspective view of the autonomous package transfer system from FIG. 1 illustrating the first transfer assembly in the extended position;

FIGS. 6A through 6C show perspective views of the first locker assembly from FIG. 1 illustrating an organizing mechanism;

FIG. 7 shows a perspective view of the first locker assembly from FIG. 1 illustrating a locker door in various positions to permit access to the organizing mechanism;

FIG. 8 shows a perspective view of the first transfer assembly delivering a package to the locker assembly from FIG. 1;

FIG. 9 shows a perspective view of the first transfer assembly retrieving a package from the first locker assembly from FIG. 1;

FIG. 10 shows a perspective front view of the autonomous package transfer system including the autonomous vehicle and a second locker assembly in accordance with a second embodiment;

FIG. 11 shows a perspective view a second organizing mechanism of the second locker assembly of the FIG. 10;

FIG. 12 shows a perspective view of a series of aligned second locker assemblies;

FIG. 13 shows a perspective front view of the autonomous package transfer system including a pair of autonomous vehicles transferring at least one package therebetween;

FIG. 14 shows a perspective front view of an autonomous vehicle delivery system including an autonomous vehicle with a modular construction;

FIG. 15 shows a perspective rear view of the autonomous vehicle;

FIG. 16 shows a side view of the autonomous vehicle;

FIG. 17 shows a top view of the autonomous vehicle;

FIG. 18 shows a perspective view of the autonomous vehicle wherein a storage assembly is removed from a chassis assembly;

FIG. 19 shows a perspective view of the autonomous vehicle delivery system including a third locker assembly and the autonomous vehicle parked therein;

FIG. 20 shows a cross-sectional view of the autonomous vehicle delivery system of FIG. 19 including a second transfer assembly that moves boxes from a storage module to the third locker assembly;

FIG. 21 shows a top view of the second transfer assembly illustrating a series of push-pull trays;

FIG. 22 is an end view of the third locker assembly and the autonomous vehicle parked therein;

FIG. 23 is an end view of a fourth locker assembly and the autonomous vehicle delivering mail and small items thereto; and

FIG. 24 shows a perspective view of the autonomous vehicle delivery system including a plurality of the autonomous vehicles, locker assemblies, and additional features.

### DESCRIPTION OF THE ENABLING EMBODIMENT

Example embodiments will now be described more fully with reference to the accompanying drawings. In general, the subject disclosure is directed to an autonomous package transfer system including at least one autonomous vehicle and a locker assembly. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the autonomous package transfer system including an autonomous vehicle and a locker assembly is intended for providing a system that is easily adaptable and serviceable and capable of safely delivering, transferring, and storing items of various sizes and qualities to recipients.

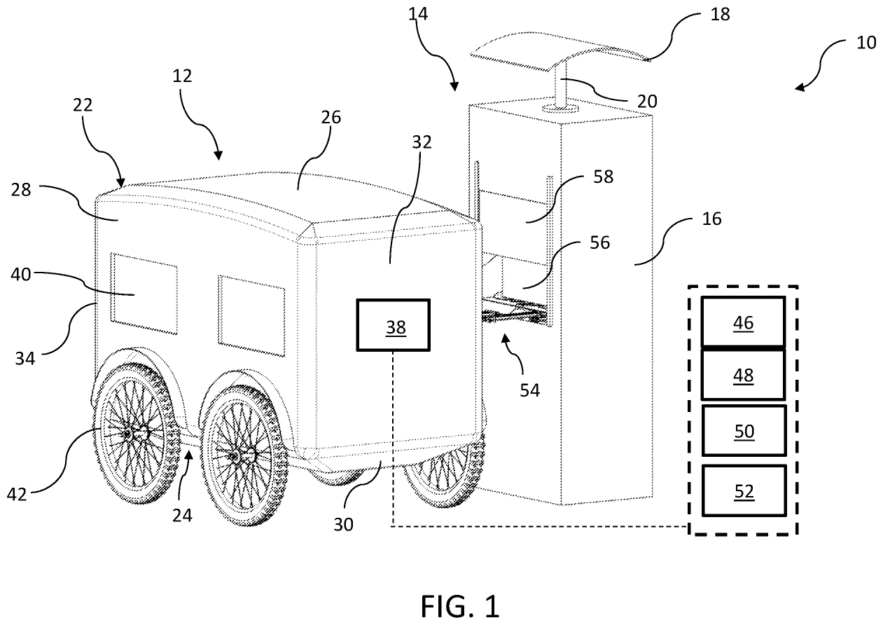

Referring initially to FIG. 1, the autonomous package transfer system 10 is generally indicated and includes at least one autonomous vehicle 12 and a first locker assembly 14. The autonomous vehicle 12 may be configured to drive between an origin location and a destination without a human driver onboard the autonomous vehicle 12. In some embodiments, the autonomous vehicle 12 may include one or more computers and sensors to enable the autonomous vehicle 12 to drive between the origin location and the destination without any human input.

The autonomous vehicle 12 includes a storage assembly 22 and a chassis assembly 24. In some embodiments, the chassis assembly 24 may be configured as a skateboard assembly. The storage assembly 22 is configured to be selectively attached and removed from the chassis assembly 24. In use, items can be loaded into the storage assembly 22 at a departure location whereafter the storage assembly 22 is moved to at least one delivery destination. The storage assembly 22 includes a body having a top surface 26 extending between a pair of sides 28 and spaced from a bottom surface 30 by the pair of sides 28. In some embodiments, the top surface 26 may include one or more solar cells to provide passive energy to the autonomous vehicle 12. The storage assembly 22 extends between a front end 32 and a rear end 34. In some embodiments, the first locker assembly 14 may include a first storage compartment 16 and a first top panel 18 connected to the first storage compartment 16 with a first bar 20. The first top panel 18 may be curved and include one or more solar cells.

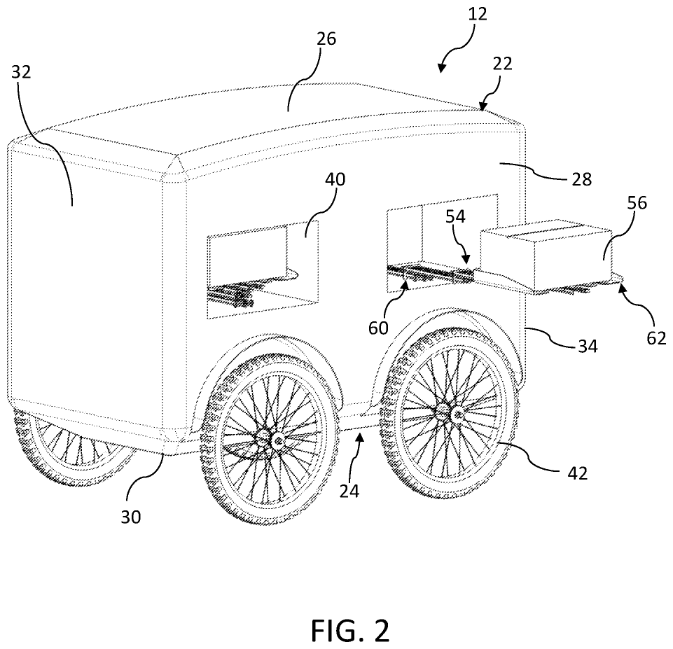

In some embodiments, the storage assembly 22 may be connected to the chassis assembly 24 such that the front end 32 is generally aligned forward facing during movement. In some embodiments, the storage assembly 22 may generally have a rectangular cuboid shape. The front end 32 may include at least one source of front illumination and/or sensing 38. The front illumination and/or sensing 38 may include cameras, LIDAR, sensors, lights, other features, or combinations thereof. The storage assembly 22 includes at least one door 40 for adding and removing items therein. The chassis assembly 24 may include at least one wheel 42. In some embodiments, the chassis assembly 24 may include a plurality of wheels 42, for example, two front wheels and four rear wheels. As best illustrated in FIG. 2, the rear end 34 may include at least one source of rear illumination and/or sensing (not shown). The rear illumination and/or sensing may include cameras, LIDAR, sensors, lights, other features, or combinations thereof. While the terms “front” and “rear” are provide to differentiate between sides of the autonomous vehicle 12, it should be appreciated that the autonomous vehicle 12 may be designed to travel with equal control in either forward or rearward directions.

The front or rear illumination and/or sensing 38 may include any number of autonomous steering modules 46, sensors 48, cameras 50, and controllers 52 for dictating the speed, direction, travel path, and obstacle avoidance of the autonomous vehicle 12 and the opening and closing of the at least one door 40. In some embodiments, the chassis assembly 24 may be electrically connected to the storage assembly 22 (wired or wirelessly) such that a controller 52 may control features of the chassis assembly 24 (e.g., braking, propulsion) and the storage assembly 22 (e.g., opening and closing the door 40). In some embodiments, the at least one door 40 includes two or more of the doors 40 on one of the sides 28 of the storage assembly 22. Each of the doors 40 may be configured as a roller-style door that is located on a belt (not shown) and moved between an open position and a closed position with a friction roller (not shown). In other embodiments, each of the doors 40 may open and close via other mechanisms, such as a chain and pulley. Operation of the door 40 may be via the one or more controllers 52.

The storage assembly 22 may be selectively connected to the chassis assembly 24 via a series of latches (not shown). The chassis assembly 24 includes a battery housing (not shown) for storing one or more battery modules (now shown). The chassis assembly 24 may further include at least one propulsion assembly (not shown) for driving the wheels 42. In some embodiments, the at least one propulsion assembly includes in-wheel motors for individually controlling the rotation of one or more of the wheels 42. As will be described in greater detail below, the autonomous vehicle 12 may include a first transfer assembly 54 for transferring packages 56 between the storage assembly 22 and the first locker assembly 14. While the package 56 is illustrated as a box, it may be any sized and shaped container and/or element that is delivered and retrieved.

With continued reference to FIG. 1, the first locker assembly 14 may include at least one locker door 58. The locker door 58 may be configured as a roller-style door that is located on a belt (not shown) and moved between an open position and a closed position with a friction roller (not shown). In other embodiments, the locker door 58 may open and close via other mechanisms, such as a chain and pulley. Operation of the locker door 58 may be via the one or more controllers 52. The one or more controllers 52 may include a controller located on the autonomous vehicle 12 and a controller located in the first locker assembly 14.

FIG. 2 is a side view of the autonomous vehicle 12 from FIG. 1 illustrating a first transfer assembly 54. The first transfer assembly 54 includes a retractable arm 60 and a carrier 62. At least one first transfer assembly 54 may be located interior of each door 40. In use, the carrier 62 holds a package 56 in an interior of the storage assembly 22 until it reaches the first locker assembly 14, whereafter the door 40 opens and the retractable arm 60 extends the carrier 62 (and package 56) outwardly and into the first locker assembly 14.

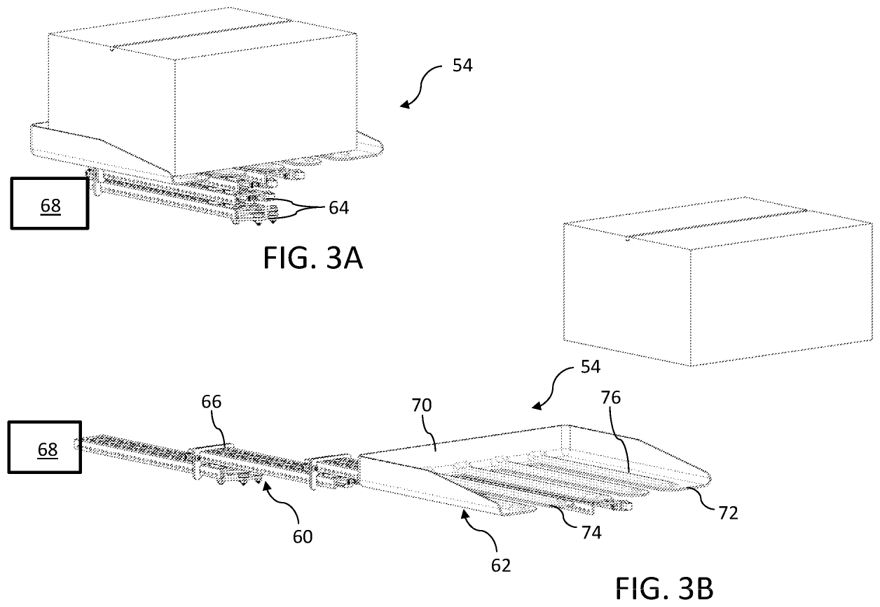

FIG. 3A is a perspective view of the first transfer assembly 54 in a stowed position, wherein the retractable arm 60 and the carrier 62 are inside the storage assembly 22. FIG. 3B is a perspective view of the first transfer assembly 54 in an extended position, wherein the retractable arm 60 has been extended and the carrier 62 is located outside of the storage assembly 22 and into the first locker assembly 14. The retractable arm 60 includes a series of linkages 64 (e.g., four linkages), each linkage 64 is connected to an adjacent one of the linkages 64 by a bracket 66 and an actuator mechanism 68 (e.g., a lead screw, rack and pinion, belt, rollers, tracks and guides, driven gear arrangements, or combinations thereof). Each of the linkages 64 may include a C-shaped cross-section with a series of apertures alongside edges.

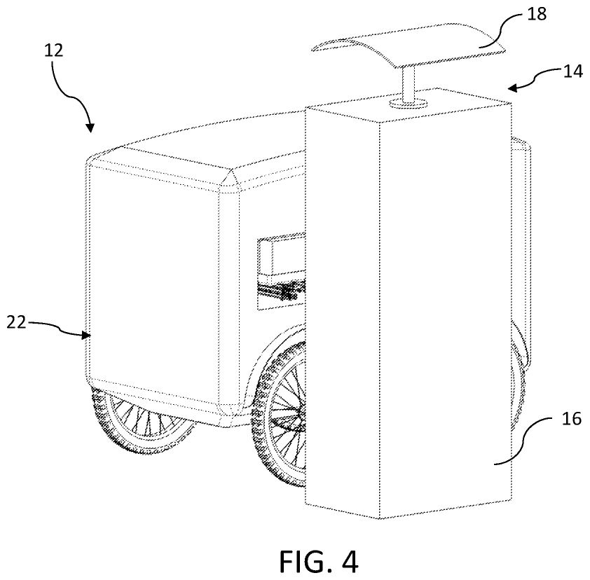

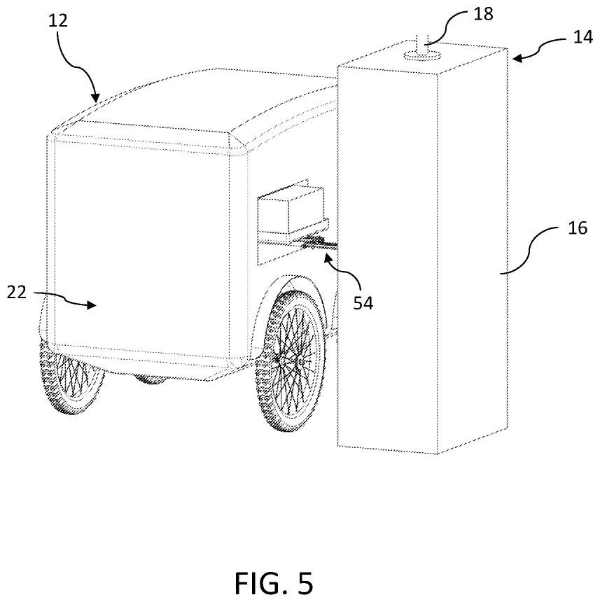

The brackets 66 may be fixedly connected to one of two linkages 64 located adjacent to one another, via screws inserted into the apertures and slideably connected to the other adjacent one of the linkages 64. Thus, during operation, two adjacent ones of the linkages 64 may move relative to one another via the actuator mechanism 68. The linkages 64 may be collapsible in a stacked configuration as shown in FIG. 3A. Alternatively or additionally, the linkages 64 may have a telescopic configuration, e.g. wherein one C-shape fits within an adjacent C-shape. Alternatively or additionally, the linkages 64 may have some combination of a stacked configuration and a telescopic configuration. The carrier 62 may be generally shovel-shaped and include a sidewall 70 around an inner and a pair of side edges and a floor 72. The floor 72 may include a series of prongs 74 with molded supports 76. The sidewall 70 on the side edges may be tapered towards a front edge of the carrier 62. FIG. 4 is a perspective view of the autonomous package transfer system 10 from FIG. 1 illustrating the first transfer assembly 54 in the stowed position. FIG. 5 is a perspective view of the autonomous package transfer system 10 from FIG. 1 illustrating the first transfer assembly 54 in the extended position, placing a package 56 in the first locker assembly 14.

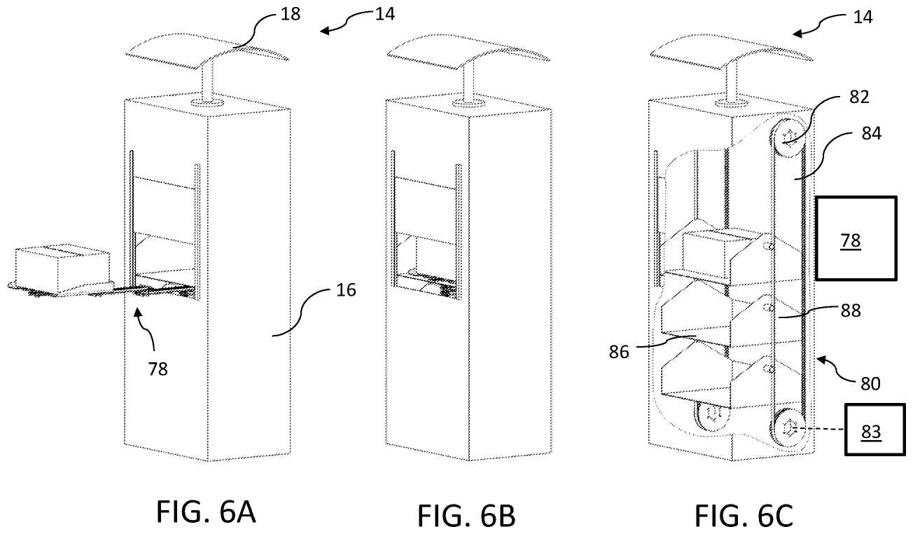

FIGS. 6A and 6B are perspective views of a series of the locker assemblies 14 from FIG. 1 illustrating a transfer mechanism 78 that may be located in the first locker assembly 14. The transfer mechanism 78 may operate and be configured in the same or a similar way to the first transfer assembly 54. FIG. 6C is a perspective view of the first locker assembly 14 with a sidewall removed to illustrate a first organizing mechanism 80 therein. The first organizing mechanism 80 may be used in conjunction with or without the transfer mechanism 78 (e.g., by providing a wider exterior housing of the first storage compartment 16). The first organizing mechanism 80 may include a pair of drive pulleys 82 that drive and/or guide a belt 84. A plurality of baskets 86 may be connected to the belt 84. In use, packages 56 may be placed on the baskets 86 and driven by the belt 84 until they are in vertical alignment with the locker door 58. Each basket 86 may include a sidewall 88 that extends around side edges. In some embodiments, the sidewall 88 may further extend around a back edge. The drive pulleys 82 and/or the belt 84 may be driven by a drive unit 83 (e.g., a motor and/or the like).

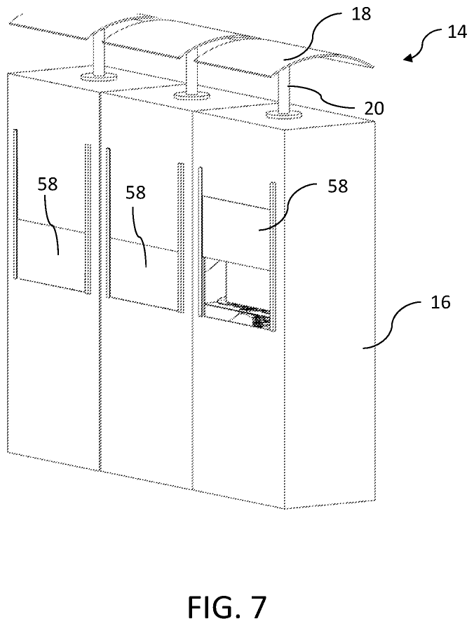

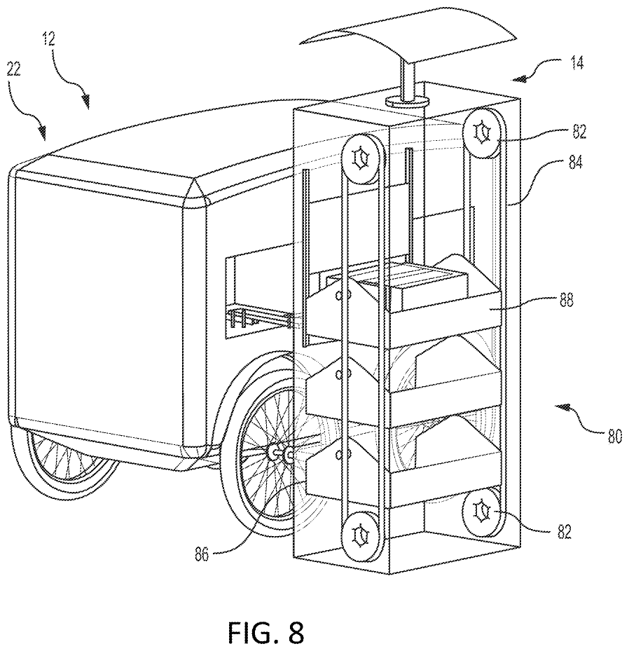

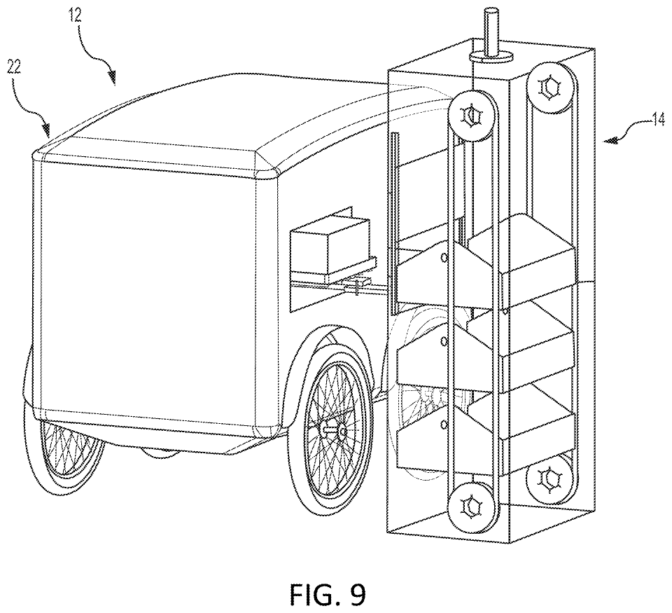

FIG. 7 is a perspective view of the first locker assembly 14 from FIG. 1 illustrating the locker door 58 in various positions to permit access to the first organizing mechanism 80. In some embodiments, a plurality of locker assemblies 14 may be aligned and controllers therein may be provided with an identifying module. The identifying module may further be associated with each basket 86, first transfer assembly 54, doors 40, packages 56, or combinations thereof. Packages 56 may further include readable codes (e.g., a QR code, a bar code, and/or the like) and the autonomous vehicle 12 may further include a scanner for reading the readable code. FIG. 8 is a perspective view of the autonomous vehicle 12 delivering a package to the first locker assembly 14 from FIG. 1. FIG. 9 is a perspective view of the autonomous vehicle 12 retrieving a package from the storage assembly 22 from FIG. 1.

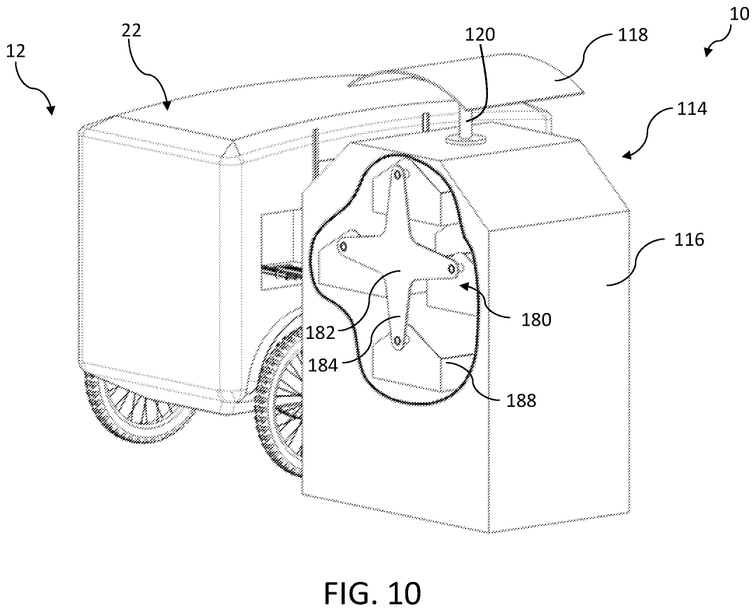

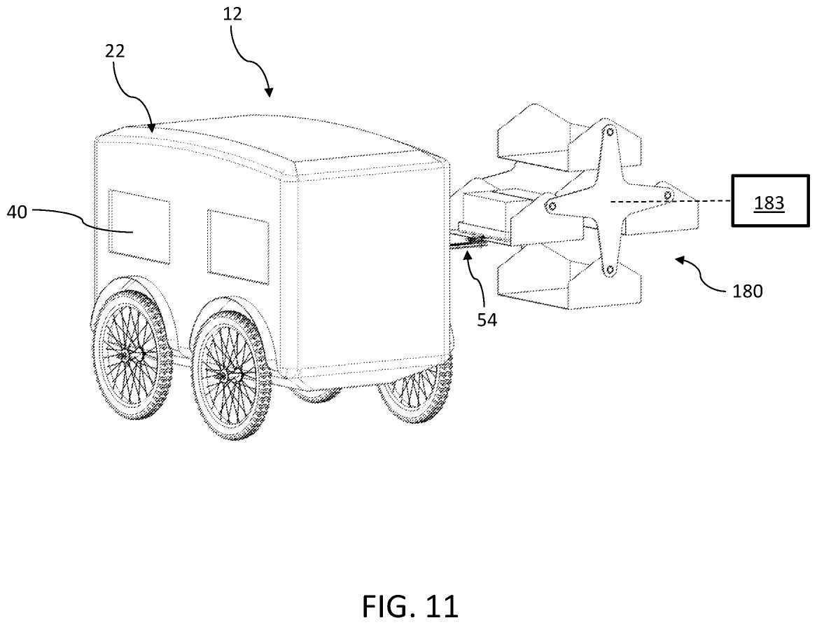

FIG. 10 is a perspective front view of the autonomous package transfer system 10 including the autonomous vehicle 12 and a second locker assembly 114 in accordance with a second embodiment. Unless otherwise stated, the second locker assembly 114 may include all the same features, components, and constructions as the other embodiments. In some embodiments, the second locker assembly 114 includes a second storage compartment 116 and a second top panel 118 connected to the second storage compartment 116 with a second bar 120. The second top panel 118 may be curved and include one or more solar cells. In some embodiments, the second locker assembly 114 includes a second organizing mechanism 180. The second organizing mechanism 180 includes a pair of rotating plates 182 rotationally connected by a shaft (not shown). The shaft may be driven by drive unit 183 (e.g., a motor and/or the like). A plurality of baskets 186 may be equally spaced about the shaft in a circumferential array. Each of the baskets 186 may be pivotally connected to the rotating plates 182 such that a top surface of each basket 186 remains oriented towards the second top panel 118. Each of the rotating plates 182 may be circular shaped or include a plurality of aligned spokes 184, with a basket 186 connected between the aligned spokes 184 of each rotating plate 182. FIG. 11 is a perspective view a second organizing mechanism 180 of the second locker assembly 114 of FIG. 10, wherein the second storage compartment 116 has been removed.

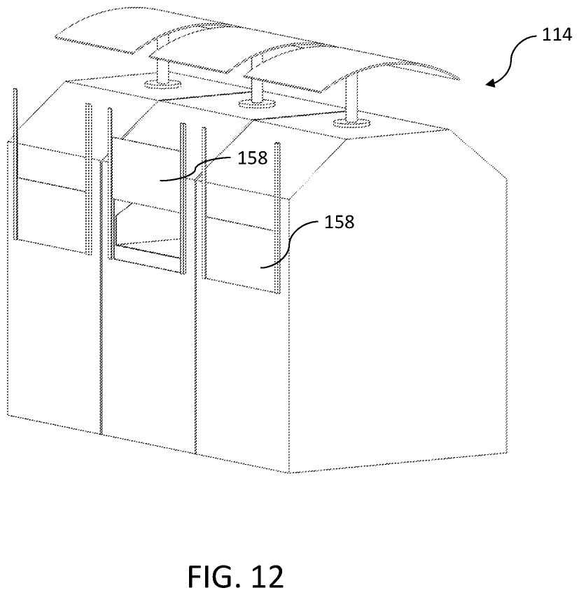

FIG. 12 is a perspective view of a series of locker assemblies 114 aligned with one another and illustrating a locker door 158 in various positions to permit access to the second organizing mechanism 180. In some embodiments, a plurality of the locker assemblies 14, 114, or a combination thereof may be aligned and controllers therein may be provided with an identifying module. The identifying module may further be associated with each basket 86, 186, first transfer assembly 54, doors 40, packages 56, or combinations thereof. Packages 56 may further include readable codes (e.g., a QR code, a bar code, and/or the like) and the autonomous vehicle 12 may further include a scanner for reading the readable code.

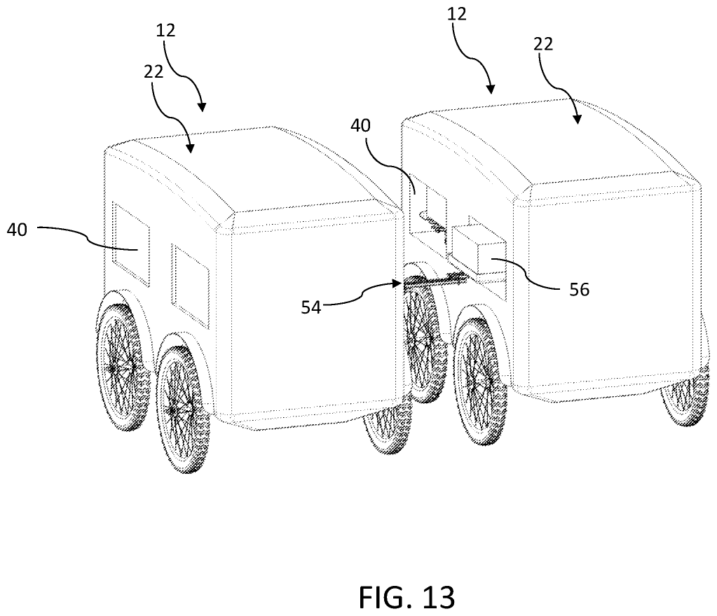

FIG. 13 is a perspective front view of the autonomous package transfer system including a pair of autonomous vehicles 12 transferring at least one package therebetween. The autonomous vehicle 12 may include any number of sensors, cameras, and controllers for dictating the speed, direction, travel path, and obstacle avoidance. The path may be pre-programmed or dynamically optimized and routed through a cloud or satellite link. The system may be configured to drop off or pick up packages at one of the locker assemblies 14, 114 or between autonomous vehicles 12. These devices may further dictate the opening and closing of the doors 40, 58. The autonomous vehicle 12, the locker assemblies 14, 114, and devices with mobile applications may be able to communicate via a mesh network, other types of wireless networks, wired networks, or combinations thereof. It should further be appreciated that the locker assemblies 14, 114 described herein may contain a single delivery box (like home delivery), may include a one sided delivery system (e.g., commercial parking garages), or be utilized for just-in-time (“JIT”) delivery in industrial settings, or combinations thereof.

The present disclosure also provides an autonomous vehicle delivery system 200 including an autonomous vehicle 220 and a third locker assembly 268. The autonomous vehicle delivery system may provide a system that is easily adaptable and serviceable and capable of safely delivering items of various sizes and qualities to recipients.

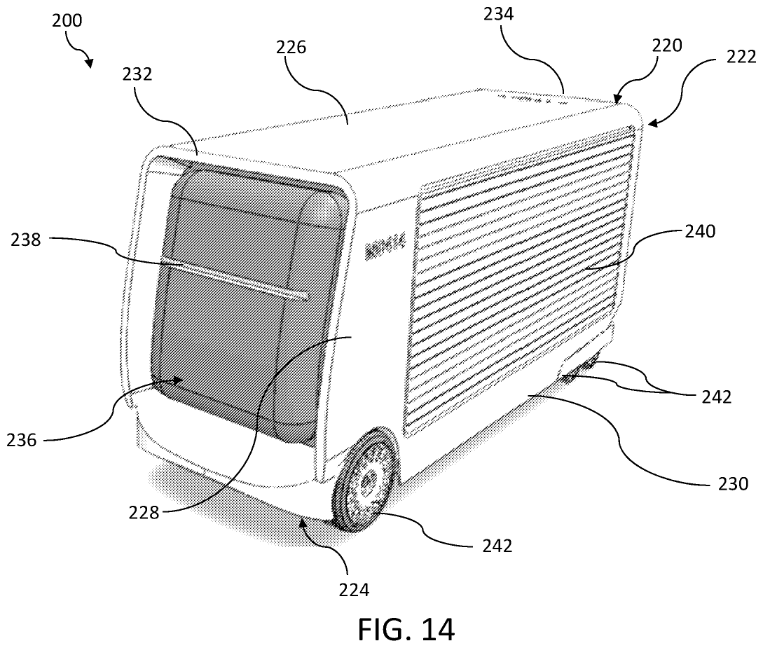

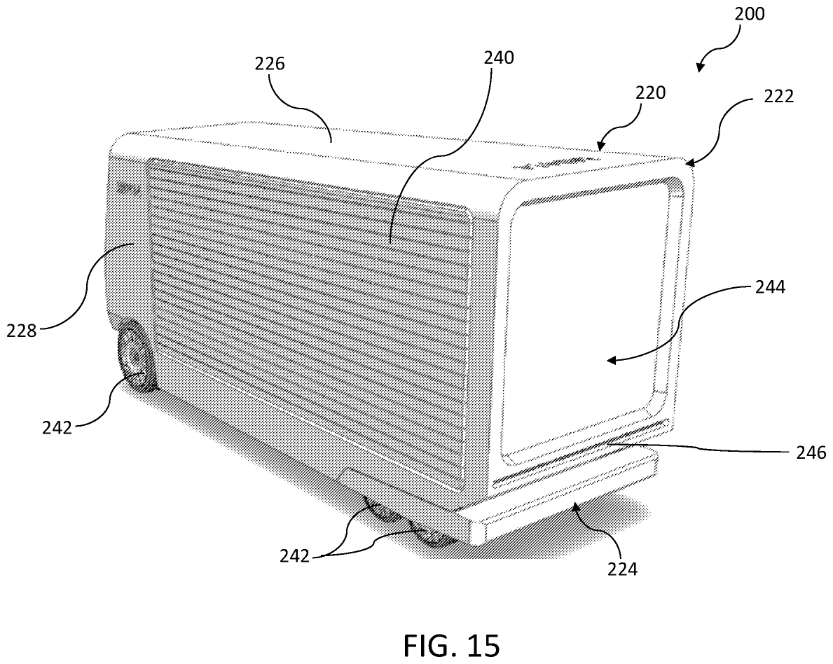

Referring to FIG. 14, the autonomous vehicle system 200 includes at least one autonomous vehicle 220. The autonomous vehicle 220 includes a storage assembly 222 and a chassis assembly 224. In some embodiments, the chassis assembly 224 may be configured as a skateboard assembly. The storage assembly 222 is configured to be selectively attached and removed from the chassis assembly 224. In use, items can be loaded into the storage assembly 222 at a departure location whereafter the storage assembly 222 is moved to at least one delivery destination. The storage assembly 222 includes a body having a top surface 226 extending between a pair of sidewalls 228 and spaced from a bottom surface 230 by the pair of sidewalls 228. The storage assembly 222 extends between a front end 232 and a rear end 234. In some embodiments, the storage assembly 222 may be connected to the chassis assembly 224 such that the front end 232 is generally aligned forward facing during movement. In some embodiments, the storage assembly 222 may generally have a rectangular cuboid shape. A front face 236 may be located adjacent to the front end 232 and may include at least one front illumination source and/or sensor 238. The front illumination source and/or sensor 238 may include cameras, LIDAR, sensors, lights, other features, or combinations thereof. The storage assembly 222 includes at least one door 240 for adding and removing items therein. The chassis assembly 224 may include at least one wheel 242. In some embodiments, the chassis assembly 224 may include a plurality of wheels 242, for example, two front wheels and four rear wheels. As best illustrated in FIG. 15, the storage assembly 222 includes a rear face 244 located adjacent to the rear end 234 and may include at least one rear illumination source and/or sensor 246. The rear illumination source and/or sensor 246 may include cameras, LIDAR, sensors, lights, other features, or combinations thereof. While the terms “front” and “rear” are provide to differentiate between sides of the autonomous vehicle 220, it should be appreciated that the autonomous vehicle 220 may be designed to travel with equal control in either forward or rearward directions.

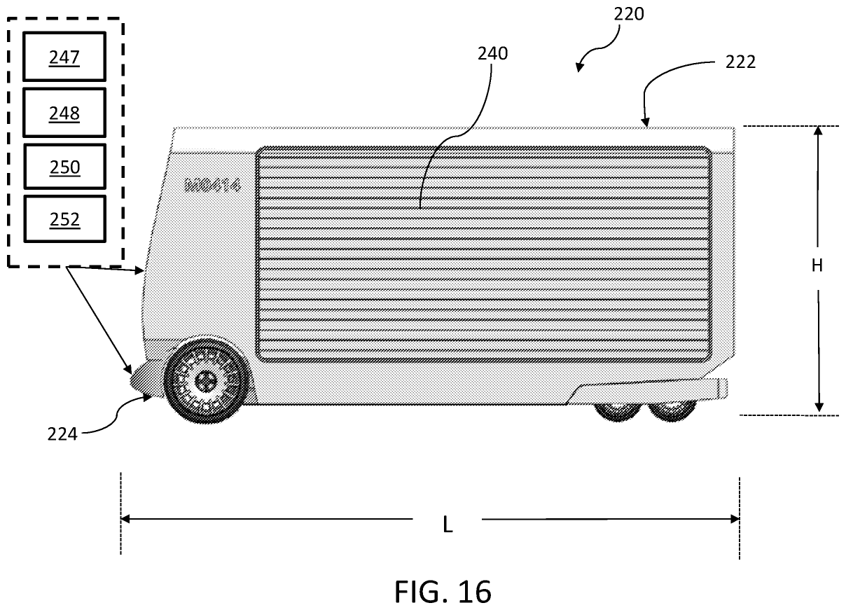

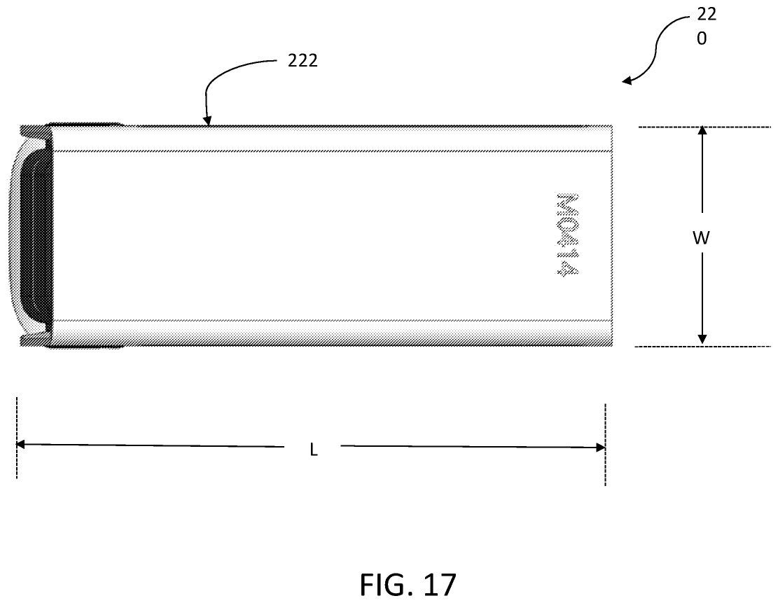

With reference now to FIG. 16, the autonomous vehicle 220 may include any number of autonomous steering modules 247, sensors 248, cameras 250, and controllers 252 for dictating the speed, direction, travel path, and obstacle avoidance of the autonomous vehicle 220 and the opening and closing of the at least one door 240. In some embodiments, the chassis assembly 224 may be electrically connected to the storage assembly 222 (wired or wirelessly) such that a controller 252 may control features of the chassis assembly 224 (e.g., braking, propulsion) and the storage assembly 222 (e.g., opening and closing the door 240). In some embodiments, the at least one door 240 includes a pair of doors 240, with one or more of the doors 240 disposed within each of the sidewalls 228 of the storage assembly 222. Each of the doors 240 may be configured as a roller-style door that is located on a belt (not shown) and moved between an open position and a closed position with a friction roller (not shown). In other embodiments, each of the doors 240 may open and close via other mechanisms, such as a chain and pulley. Operation of the door 240 may be via the one or more controllers 252. The autonomous vehicle 220 may include a length “L” and a height “H”. In some embodiments, the length L may be approximately 350 cm, for example 357 cm, and the height may be approximately 170 cm, for example 175 cm. As best illustrated in FIG. 17, the autonomous vehicle 220 may include a width “W”. In some embodiments, the width W may be approximately 150 cm, for example 130 cm.

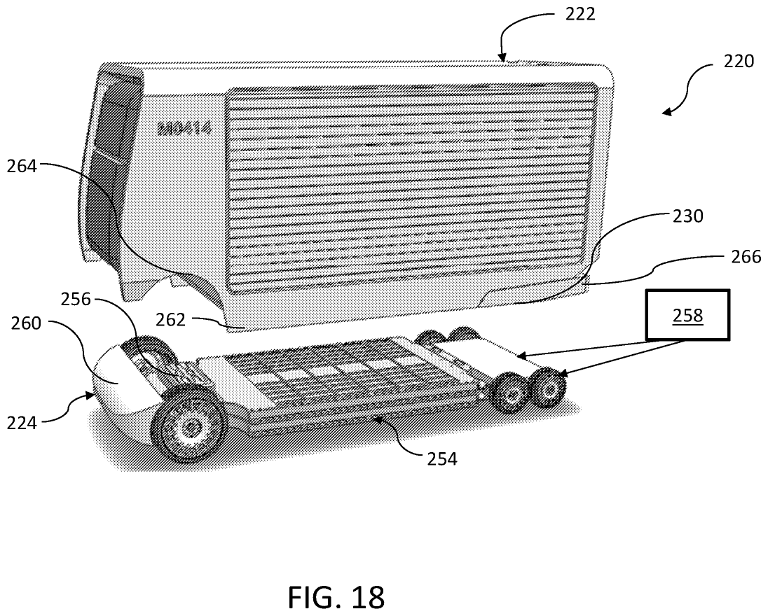

FIG. 18 is a perspective view of the autonomous vehicle 220 wherein the storage assembly 222 is removed from the chassis assembly 224. The storage assembly 222 may be selectively connected to the chassis assembly 224 via a series of latches (not shown). The chassis assembly 224 includes a battery housing 254 for storing one or more battery modules (now shown). The battery housing 254 may encase the one or more battery modules such that they are protected from environmental dangers. In some embodiments, the battery housing 254 may hold a 30 kwh battery pack with a 150 km range. The chassis assembly 224 may further include one or more communication modules 256 that pair with the storage assembly 222 to permit the transmission of various data and tasks. The chassis assembly 224 may further include at least one propulsion assembly 258 for driving the wheels 242. In some embodiments, the at least one propulsion assembly 258 includes in-wheel motors for individually controlling the rotation of one or more of the wheels 242. In some embodiments, the at least one propulsion assembly 258 may include front wheel drive and twin rear axles for each of the rear wheels 242. The chassis assembly 224 may further include a front bumper 260. In some embodiments, the bottom surface 230 of the storage assembly 222 may include an exterior rim 262 that defines an opening for placement of the chassis assembly 224. More particularly, the exterior rim 262 may extend over an entire outer periphery of the chassis assembly 224 other than the wheels 242 and the front bumper 260. In some embodiments, the front wheels 242 are larger than the rear wheels 242 and the exterior rim 262 includes a wheel well portion 264 for exposing the front wheels 242 and a rear bumper portion 266 that wraps around the rear wheels 242 (FIG. 16). Therefore, the lowest portion (other than the wheels 242) of the autonomous vehicle 220 may be the exterior rim 262 and/or the front bumper 260 to protect features of the chassis assembly 224.

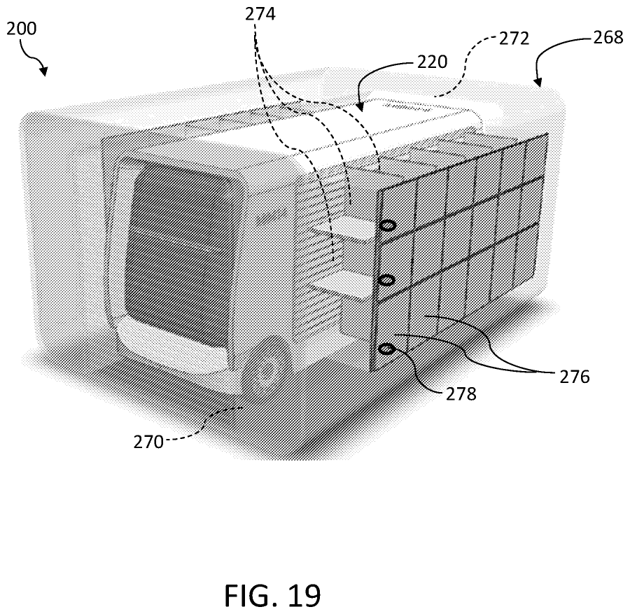

FIG. 19 is a perspective view of the autonomous vehicle delivery system 200 illustrating the third locker assembly 268 and the autonomous vehicle 220 parked therein. The autonomous vehicle delivery system 200 may include a plurality of third locker assemblies 268 and autonomous vehicles 220 that operate in concert in commercial and residential environments. The third locker assembly 268 may include a bay 270 and at least one door 272 that moves from an open to a closed position to allow entry into the bay 270. The bay 270 is sized such that the autonomous vehicle 220 can be located therein. The third locker assembly 268 may include at least one third storage compartment 274 in the interior thereof. Each storage compartment 274 may include a compartment door 276 that opens from an exterior side (e.g., sliding) in order to gain access to the third storage compartment 274.

Each compartment door 276 may include a lock 278. The third locker assembly 268 may be configured to actuate the lock 278 to a locked position in response to a package being moved into the third storage compartment 274 from the autonomous vehicle 220, and by a transfer assembly. The lock 278 may be configured to be opened with a mechanical key, a key card, mechanical or digital password input, or other devices. In some embodiments, the lock 278 may be opened via an application. For example, an application on a mobile device may allow a user to interface with and open the lock 278. The application may further provide notifications upon the delivery of items. In some embodiments, the compartment door 276 may be configured to close and lock upon removal of the item. In some embodiments, the third locker assembly 268 includes storage compartments 274 of different sizes. The storage compartments 274 that are larger may be located beneath storage compartments 274 that are smaller such that heavier and larger items are stored lower in the third locker assembly 268 and the autonomous vehicle 220.

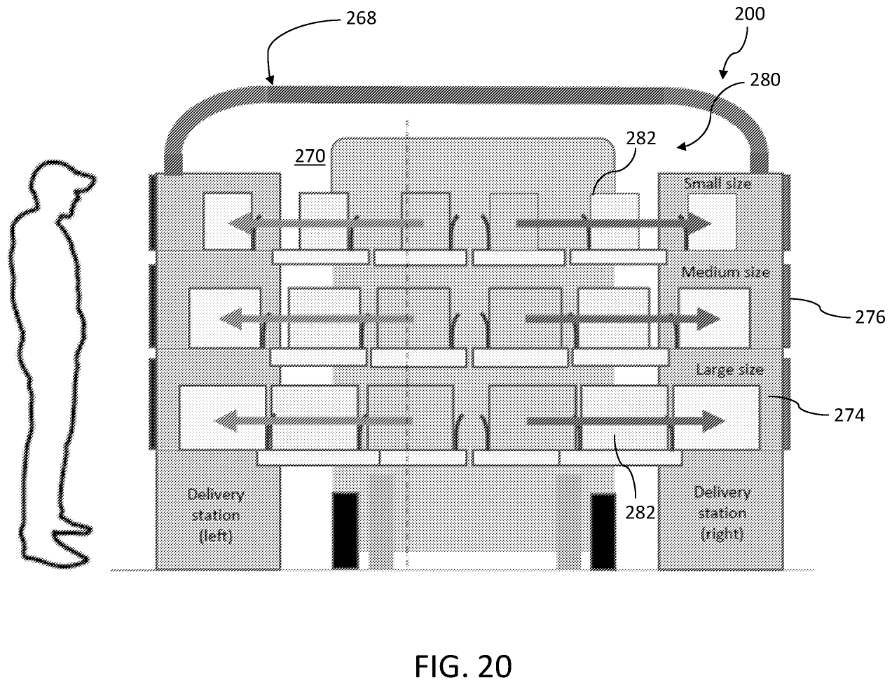

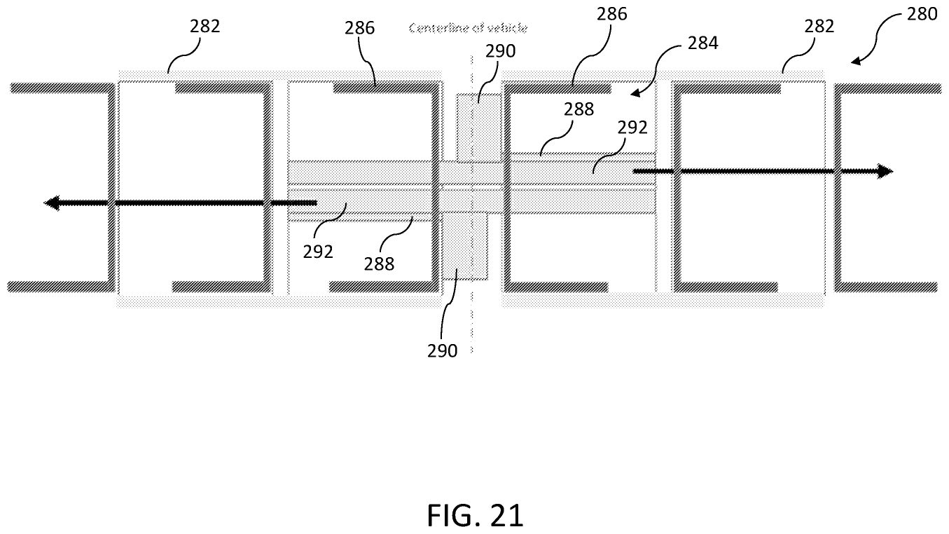

FIG. 20 is a cross-sectional view of FIG. 18 wherein the autonomous vehicle delivery system 200 includes a second transfer assembly 280 that moves items from the storage assembly 222 to the third locker assembly 268. More particularly, the storage assembly 222 may include a series of module compartments 282. The module compartments 282 and the storage compartments 274 may be equal in size, number, and distribution. For example, in some embodiments, there may be thirty-six (36) module compartments 282 and the storage compartments 274 including three standardized box sizes with the lowest level having the largest size for heavier, bulkier items such as groceries. As such, when the storage assembly 222 is located in the bay 270, the module compartments 282 become aligned with the storage compartments 274. In some embodiments, the second transfer assembly 280 includes at least one displacement unit 284. In some embodiments, the at least one displacement unit 284 includes a displacement unit 284 located in each of the module compartments 282. As best illustrated in FIG. 21, in some embodiments, each of the displacement units 284 includes a push-pull tray 286 that is moveable between a stowed position in the inner most portion of the associated module compartment 282 and a displaced position wherein the push-pull tray 286 has moved towards an outer portion of the associated module compartment 282. In some embodiments, the push-pull tray 286 is configured to move past an outer portion of the associated module compartment 282 and at least partially into an associated storage compartment 274. The push-pull tray 286 may be actuated by any number of devices. For example, a jack screw 288 driven by a servo motor 290 may move the push-pull trays between the stowed and displaced positions. In some embodiments, the push-pull trays 286 may be located on a track 292 for facilitating linear movement. In some embodiments, the displacement unit 284, the push-pull tray 286, or a separate device may be configured to grab (e.g., via mechanical fingers) or otherwise move an item, such as a package 56, from the storage compartment 274 to the module compartment 282 for retrieval rather than delivery of items.

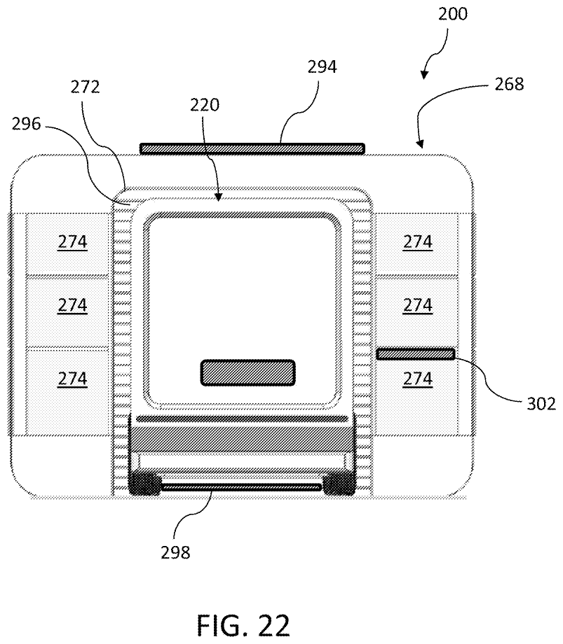

FIG. 22 is an end view of the third locker assembly 268 and the autonomous vehicle 220 parked therein. In some embodiments, the third locker assembly 268 may include one or more solar panels 294 on an exterior thereof. The at least one door 272 may include a pair of doors 272 on opposite sides of the third locker assembly 268 such that the autonomous vehicle 220 can enter one of the doors 272 and exit the other one of the doors 272 on the opposite sides of the third locker assembly 268 and without having to reverse. Each of the doors 272 may include a moveable door panel 296 that selectively opens and closes to allow entry of the autonomous vehicle 220 or service personnel. In some embodiments, the moveable door panel 296 (e.g., a multi-panel rolling door) may be configured to open and close based on a proximity of the autonomous vehicle 220 and/or a request to open from the one or more controllers 252. One or more charging modules 298 may be located at the third locker assembly 268 to charge the one or more battery modules in the battery housing 254 during the transfer of items. The charging module 298 may be configured to charge the battery modules via inductance or a direct connection. In some embodiments, the third locker assembly 268 includes at least one temperature control module 302 to regulate a temperature within at least one of the storage compartment 274. Therefore, in instances wherein perishable items are being delivered, a storage compartment 274 may be assigned to the perishable item to keep it at a lower or higher temperature than ambient and preserve the item. In some embodiments, a temperature control module may also be located in the autonomous vehicle 220 (not shown). The third locker assemblies 268 may be strategically placed in environments based on population density. In some embodiments, each of the autonomous vehicles 220 may include a self-leveling system with cameras (e.g., 3D vision systems) to align the autonomous vehicle 220 with the third locker assembly 268 once it is located in the bay 270. Leveling may be achieved mechanically based on feedback from the self-leveling camera system and the at least one controller 252.

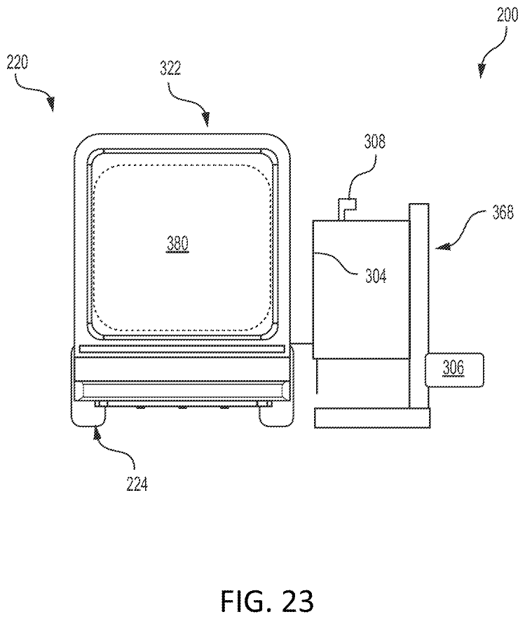

FIG. 23 shows an end view of the autonomous vehicle delivery system 200 wherein the autonomous vehicle 220 includes a modified storage assembly 322 that is configured to store mail and other small items. The mail and other small items may be delivered (or retrieved) with a fourth locker assembly 368. The fourth locker assembly 368 may be similar in general shape and functionality as a mailbox with some additional smart features and may be particularly prevalent in suburban areas. For example, the fourth locker assembly 368 may include a locker door 304 that opens upon certain conditions. In some embodiments, the locker door 304 may be configured to open and close based on a proximity of the autonomous vehicle 220 and/or a request to open from the one or more controllers 252. The fourth locker assembly 368 may include an energy module 306, such as a direct connection to an electrical grid, a solar panel and battery, or other devices. A notification device 308 may provide a status of the fourth locker assembly 368, for example, it may notify a recipient of an item or mail that it has been delivered. The notification device 308 may be configured to move, illuminate, or otherwise notify a recipient based on a request by the one or more controllers 252. A notification may further be sent by the one or more controllers 252 to a mobile device via the application. The storage assembly 322 may include a third transfer assembly 380 specifically configured for delivering or retrieving mail and other small items. The third transfer assembly 380 may include a chute (not shown) for routing mail and small items designated for a fourth locker assembly 368. In some embodiments, the third transfer assembly 380 may include one or more features of U.S. Pat. No. 3,430,951, which is incorporated herein by reference. In some embodiments, the third transfer assembly 380 may further include a suction chute or mechanical fingers for retrieving the mail or small items. As such, the number of module compartments 282 may not limit the number of fourth locker assemblies 368 that are being delivered to. However, it should be appreciated that in some embodiments, a locker assembly that shares a combination of features as those shown in FIG. 20 and FIG. 23 may be utilized such that a variety of items and mail can be delivered by a single autonomous vehicle 220. Moreover, it should be appreciated that the locker assembly and/or storage modules may be configured for other tasks, such as moving people between locations, delivering warm food, etc.

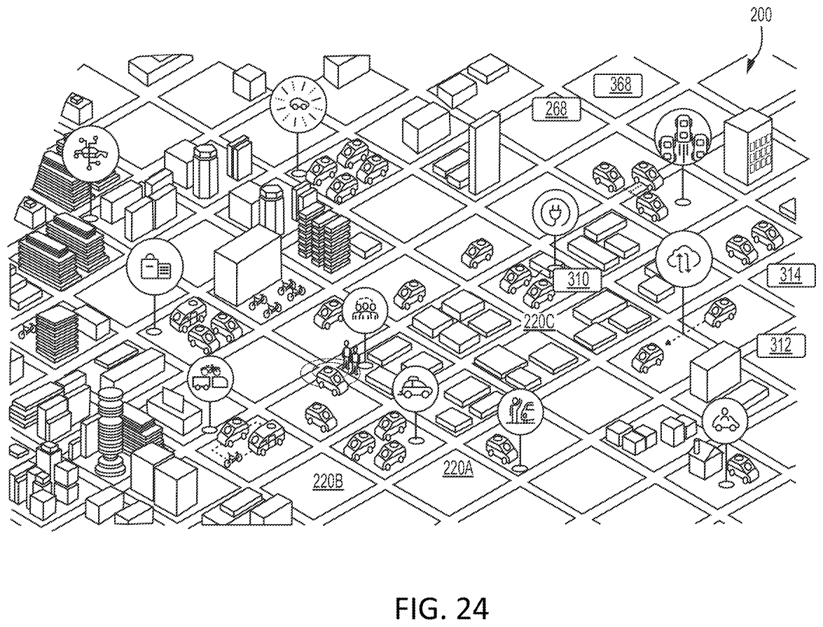

FIG. 24 is a perspective view of the autonomous vehicle delivery system including a plurality of the autonomous vehicles 220A-220N (N representing all natural numbers), locker assemblies 14, 114, 268, 368, battery charging assemblies 310, service stations 312, and pick-up/drop-off facilities 314. A fleet of the autonomous vehicles 220A-220N may be located near a pick-up/drop-off facility 314 such that an appropriate storage assembly 222, 322 can be selected, items and mail can be loaded in the module compartments 282, and the battery modules can be charged and/or swapped. After the fleet of the autonomous vehicles 220A-220N are loaded, the autonomous vehicles 220A-220N are assigned specific tasks via one of the controllers 252. In some instances an assigned task may include range outside of a range of the battery modules, as such, the assigned task may include traveling to a battery charging assembly 310 before or after delivery. The assigned task may also include traveling to one or more locker assemblies 14, 114, 268, 368 to drop-off items and/or mail. After dropping-off the items and/or mail, the autonomous vehicles 220A-220N may travel back to the pick-up/drop-off facilities 314. Moreover, if a controller 252 receives a signal that one or more features of the autonomous vehicles 220A-220N is defective, the controller 252 may generate a signal to travel to a nearby service station 312.

The autonomous vehicles 220A-220N may include any number of sensors, cameras, and controllers for dictating the speed, direction, travel path, and obstacle avoidance. The path may be pre-programmed or dynamically optimized and routed through a cloud or satellite link. The system could be designed to drop off or pick up packages at each location. These devices may further dictate the opening and closing of the doors 240 and the transfer assembly 54, 280, 380. The autonomous vehicles 220A-220N, the locker assemblies 14, 114, 268, 368, and devices with mobile applications may be able to communicate via a mesh network, other types of wireless networks, wired networks, or combinations thereof. It should further be appreciated that the storage assemblies 222, 322 described herein could contain a single delivery box (like home delivery), could remove the entire storage assembly 222, 322 as a delivery pod, could include a one sided delivery system (e.g., commercial parking garages), or be utilized for just-in-time (“JIT”) delivery in industrial settings, or combinations thereof.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. An autonomous package transfer system comprising:
a locker assembly located at a destination and including a storage compartment having a locker door that is moveable between an open position and a closed position;
an autonomous vehicle including a storage assembly; and
a transfer assembly configured to move a package between the storage assembly of the autonomous vehicle and the storage compartment of the locker assembly.

2. The autonomous package transfer system of claim 1, wherein the transfer assembly is fixedly connected to the autonomous vehicle.

3. The autonomous package transfer system of claim 1, wherein the transfer assembly is fixedly connected to the locker assembly.

4. The autonomous package transfer system of claim 1, wherein the transfer assembly includes an extendable arm and a carrier for moving the package between the storage assembly of the autonomous vehicle and the storage compartment of the locker assembly.

5. The autonomous package transfer system of claim 1, wherein the autonomous vehicle further includes a chassis assembly having a propulsion assembly and at least one front wheel and at least one rear wheel;
wherein the storage assembly is configured to selectively attach to the chassis assembly and be moved by the chassis assembly to the destination; and
wherein the storage assembly includes at least one storage module for holding a corresponding item.

6. The autonomous package transfer system of claim 1, wherein the storage compartment further includes a lock to selectively prevent access to the storage compartment; and
wherein the locker assembly is configured to actuate the lock to a locked position in response to the package being moved into the storage compartment by the transfer assembly.

7. The autonomous package transfer system of claim 1, further comprising an organizing mechanism located in the storage compartment and including a plurality of baskets, wherein each of the baskets are moveable into alignment with the locker door via a drive unit.

8. The autonomous package transfer system of claim 7, wherein the organizing mechanism includes a pulley and a belt, wherein each of the baskets are connected to the belt and the belt is driven by the pulleys.

9. The autonomous package transfer system of claim 7, wherein the organizing mechanism includes a pair of rotating plates connected by a shaft, wherein the baskets are pivotally connected between the pair of rotating plates.

10. The autonomous package transfer system of claim 1, wherein the storage assembly of the autonomous vehicle includes a plurality of storage modules each configured to hold a corresponding item; and
wherein the transfer assembly includes at least one displacement unit in each of the storage modules and configured to move the corresponding item out of the storage assembly of the autonomous vehicle and into the storage compartment of the locker assembly.

11. The autonomous package transfer system of claim 10, wherein the storage compartment is one of a plurality of storage compartments in the locker assembly; and
wherein the locker assembly further includes a bay sized to receive the autonomous vehicle.

12. The autonomous package transfer system of claim 11, wherein the storage modules are configured to be aligned with at least one of the storage compartments and wherein the displacement unit includes a push-pull tray for moving the package from one of the storage modules to one of the storage compartments.

13. The autonomous package transfer system of claim 12, wherein the locker door is one of a plurality of locker doors, with each of the plurality of storage compartments in the locker assembly including a corresponding one of the plurality of locker doors, and wherein each of the plurality of locker doors is spaced away from the bay.

14. An autonomous package transfer system comprising:
a locker assembly located at a destination and including a storage compartment having a locker door that is moveable between an open position and a closed position;
an autonomous vehicle including a storage assembly and a chassis assembly; and
a transfer assembly configured to move a package between the storage assembly of the autonomous vehicle and the storage compartment of the locker assembly,
wherein the chassis assembly includes a propulsion assembly and at least one front wheel and at least one rear wheel,
wherein the storage assembly is configured to selectively attach to the chassis assembly and be moved by the chassis assembly to the destination, and
wherein the storage assembly includes at least one storage module for holding a corresponding item.

15. The autonomous package transfer system of claim 14, further comprising an organizing mechanism located in the storage compartment and including a plurality of baskets, wherein each of the baskets are moveable into alignment with the locker door via a drive unit, and wherein the organizing mechanism includes at least one of:
a pulley and a belt, wherein each of the baskets are connected to the belt and the belt is driven by the pulleys; or
a pair of rotating plates connected by a shaft, wherein the baskets are pivotally connected between the pair of rotating plates.

16. The autonomous package transfer system of claim 14, wherein the locker assembly further includes:
a bay sized to receive the autonomous vehicle; and
a pair of vehicle doors located on opposite sides of the locker assembly and configures such that the autonomous vehicle can enter the bay through one vehicle door of the pair of vehicle doors and exit the bay through another vehicle door of the pair of vehicle doors, without having to reverse,
wherein each vehicle door of the pair of vehicle doors includes a movable door panel.

17. The autonomous package transfer system of claim 16, further including a controller configured to cause the one vehicle door of the pair of vehicle doors to open based on a proximity of the autonomous vehicle.

18. An autonomous package transfer system comprising:
a locker assembly located at a destination and including a plurality of storage compartments, each storage compartment of the plurality of storage compartments having a locker door that is moveable between an open position and a closed position;
an autonomous vehicle including a storage assembly; and
a transfer assembly configured to move a package between the storage assembly of the autonomous vehicle and a corresponding storage compartment of the plurality of storage compartments of the locker assembly,
wherein the locker assembly further includes a bay sized to receive the autonomous vehicle.

19. The autonomous package transfer system of claim 18, wherein the storage assembly of the autonomous vehicle includes a plurality of storage modules each configured to hold a corresponding item,
wherein the transfer assembly includes at least one displacement unit in each of the storage modules and configured to move the corresponding item out of the storage assembly of the autonomous vehicle and into a storage compartment of the plurality of storage compartments of the locker assembly, and
wherein the displacement unit includes a push-pull tray for moving the package from one of the storage modules to at least one storage compartment of the plurality of storage compartments.

20. The autonomous package transfer system of claim 19, wherein the locker door is one of a plurality of locker doors, with each of the plurality of storage compartments in the locker assembly including a corresponding one of the plurality of locker doors, and wherein each of the plurality of locker doors is spaced away from the bay.
